(19) United States
(12) Patent Application Publication
(10) Pub. No.: US 2026/0015803 A1
(43) Pub. Date: Jan. 15, 2026

(54) HOSE BRIDGE EXTENDER AND RAILROAD CROSSING

(71) Applicant: Cleveland Reclaim Industries, Inc. d/b/a Turtle Plastics, Lorain, OH (US)

(72) Inventors: Tom Norton, Bay Village, OH (US); Robert Mestdagh, Ackley, IA (US); Dennis R. Hildebrandt, JR., North Olmsted, OH (US); Michael W. Jackson, Wooster, OH (US)

(21) Appl. No.: 19/332,123

(22) Filed: Sep. 18, 2025

Related U.S. Application Data
(63) Continuation of application No. 17/515,672, filed on Nov. 1, 2021, now Pat. No. 12,442,142.
Application No. 17/515,672 is a continuation of application No. 29/643,276, filed on Apr. 6, 2018, now Pat. No. D935056.
Application No. 29/643,276 is a continuation of application No. 29/584,435, filed on Nov. 15, 2016, now Pat. No. D815306.
Application No. 29/584,435 is a continuation of application No. 29/522,823, filed on Apr. 2, 2015, now Pat. No. D772431.

(51) Int. Cl. E01C 9/04; A62C 33/06; E01B 7/28; E01C 11/22

(52) U.S. Cl. CPC E01C 9/04; A62C 33/06; E01B 7/28; E01C 11/222

(57) ABSTRACT

A bridge piece that can be used as a hose bridge extender or a railroad crossing. An exemplary bridge piece has a body having an undercut proximate one side, which undercut is positioned near a track when used as part of a railroad crossing.

### CROSS-REFERENCE TO RELATED CASES

This case is a continuation of U.S. patent application Ser. No. 17/515,672, filed Nov. 1, 2021 (Attorney Docket No. 21746.04038), now U.S. Pat. No. ______, which is a continuation of U.S. patent application Ser. No. 29/643,276, filed Apr. 6, 2018, now U.S. Pat. No. D935,056, issued Nov. 2, 2021 (Attorney Docket No. 21746.04024), which is a continuation of U.S. patent application Ser. No. 29/584,435, filed Nov. 15, 2016 now U.S. Pat. No. D815,306, issued Apr. 10, 2018 (Attorney Docket No. 21746.04019), which is a continuation of U.S. patent application Ser. No. 29/522,823, filed Apr. 2, 2015, now U.S. Pat. No. D772,431, issued Nov. 22, 2016 (Attorney Docket No. 21746.04012), the entire disclosures of all of which are hereby incorporated by reference in their entireties.

### BACKGROUND

Hose bridge extensions are known, e.g., U.S. Pat. No. D552,217 to Norton.

### SUMMARY

An exemplary bridge piece can be used as either a hose bridge extender or a railroad crossing.

An exemplary bridge piece comprises a body having an undercut proximate one side, which undercut is positioned near a track when used as part of a railroad crossing; the body having second, third, and fourth sides having interlocking structures to interlock with like bridge pieces.

An exemplary method comprises providing a one or a plurality of bridge pieces capable of being a hose bridge extender or a railroad crossing; and installing the one or plurality of bridge pieces as either a hose bridge extender between other hose bridge pieces or as a railroad crossing.

### DESCRIPTION OF THE FIGURES

FIGS. 1-3 show an exemplary bridge piece;

FIG. 4 shows the bridge piece of FIGS. 1-3 used as a hose bridge extender;

FIGS. 5-6 shows the bridge piece of FIGS. 1-3 with a portion cut off;

FIG. 7 shows two of the cut bridge pieces of FIGS. 5-6 end to end; and

FIG. 8 shows two bridge pieces being installed.

An Appendix consists of the parent U.S. Ser. No. 29/643,276, filed Apr. 6, 2018 (Attorney Docket No. 21746.04024).

### DETAILED DESCRIPTION

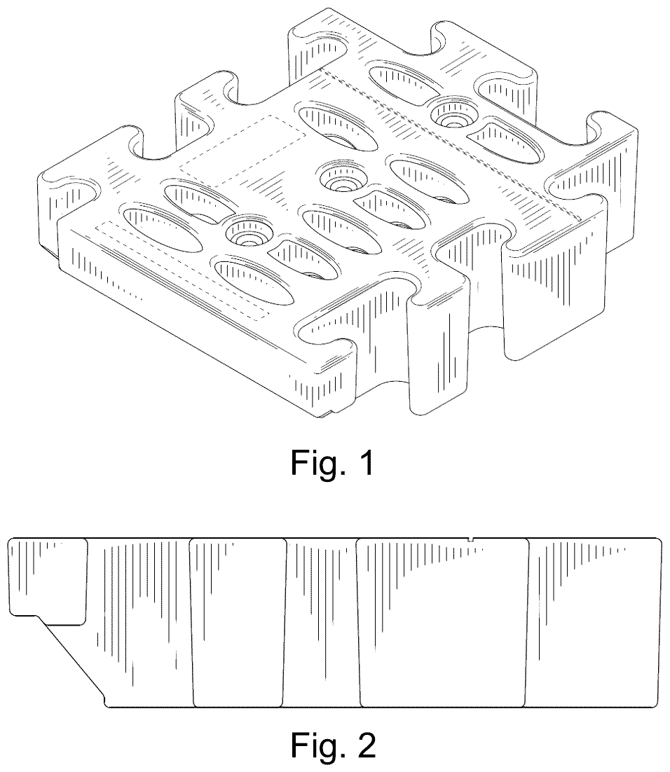

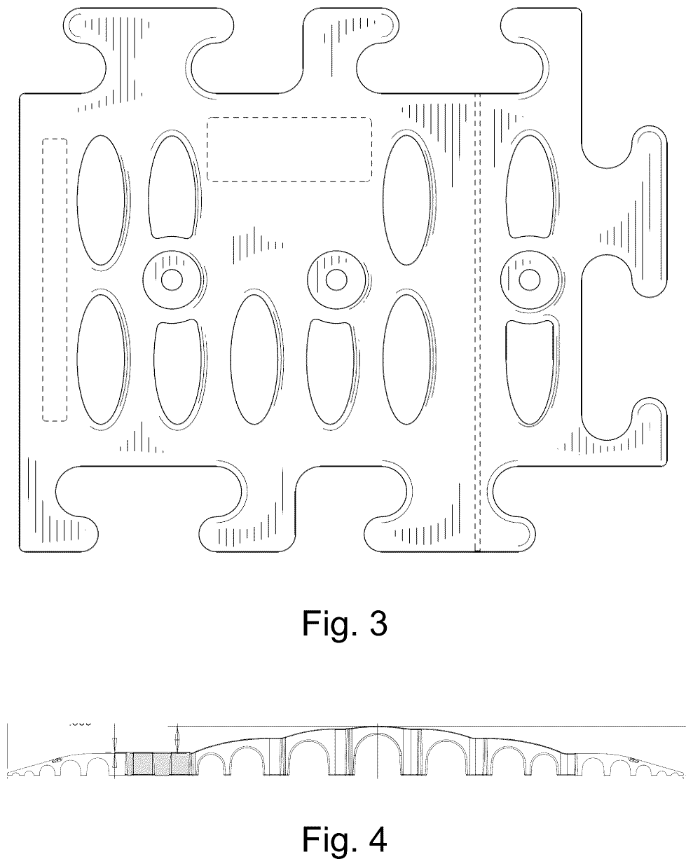

FIGS. 1-3 show an exemplary bridge piece that can be used as a hose bridge extender or a railroad crossing. FIG. 4 shows the bridge piece of FIGS. 1-3 used as a hose bridge extender.

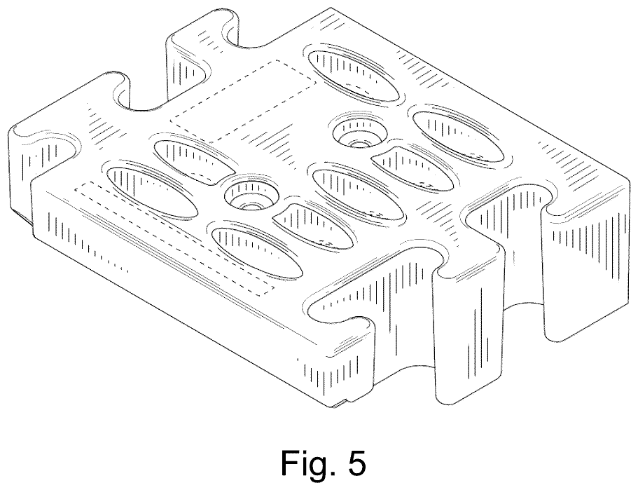

FIGS. 5-6 shows the bridge piece of FIGS. 1-3 with a portion cut off.

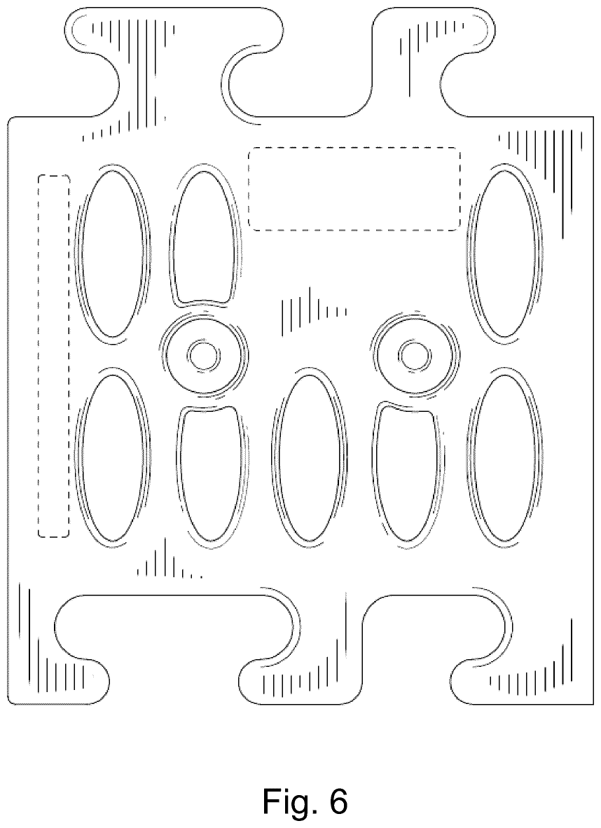

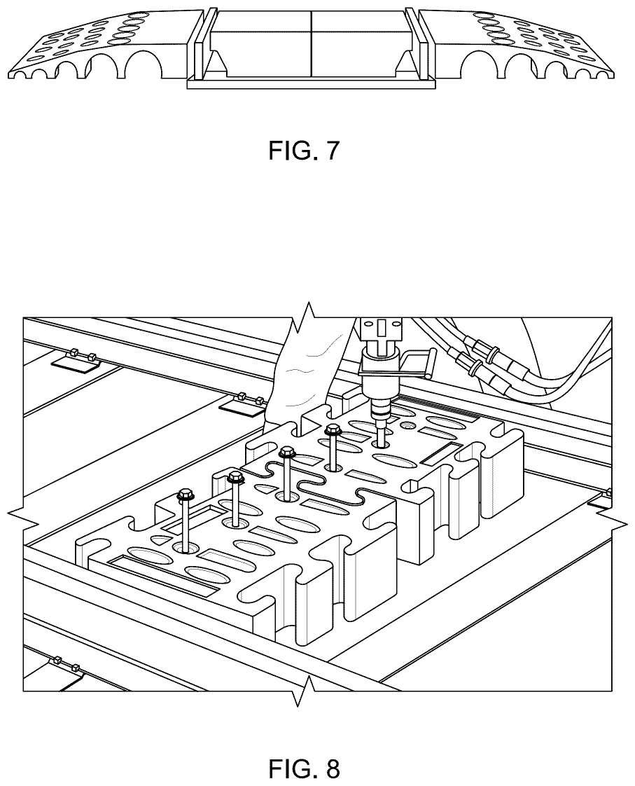

FIG. 7 shows two of the cut bridge pieces of FIGS. 5-6 end to end to form a railroad crossing. FIG. 8 shows two bridge pieces being installed as a railroad crossing.

An exemplary bridge piece comprises a body having an undercut proximate one side, which undercut is positioned near a track when used as part of a railroad crossing; the body having second, third, and fourth sides having interlocking structures to interlock with like bridge pieces. An exemplary bridge piece has a body having an undercut proximate one side, which undercut is positioned near a track when used as part of a railroad crossing.

An exemplary method comprises providing a one or a plurality of bridge pieces capable of being a hose bridge extender or a railroad crossing; and installing the one or plurality of bridge pieces as either a hose bridge extender between other hose bridge pieces or as a railroad crossing. When installing as a railroad crossing, the undercut portion is positioned near a track.

In exemplary embodiments, the bridge piece is molded.

What is claimed is:

1. A method, comprising:
providing one or a plurality of bridge pieces capable of being a hose bridge extender or a railroad crossing;
optionally cutting the plurality of bridge pieces; and
installing the one or plurality of bridge pieces as either a hose bridge extender between other hose bridge pieces or as a railroad crossing.

2. A bridge piece capable of being a hose bridge extender or a railroad crossing, comprising:
a body having an undercut proximate one side, which undercut is positioned near a track when used as part of a railroad crossing;
the body having second, third, and fourth sides having interlocking structures to interlock with like bridge pieces.
